(19) United States
(12) Patent Application Publication
(10) Pub. No.: US 2015/0052237 A1
(43) Pub. Date: Feb. 19, 2015

(54) TRANSMISSION OF LARGE DATA FILES OVER AN EXTENSIBLE SCRIPTING FILE FORMAT

(71) Applicant: Darrel B. Fenstad, Roseville, MN (US)

(72) Inventor: Darrel B. Fenstad, Roseville, MN (US)

(73) Assignee: Unisys Corporation, Blue Bell, PA (US)

(21) Appl. No.: 13/967,713

(22) Filed: Aug. 15, 2013

(51) Int. Cl. H04L 12/26

(52) U.S. Cl. CPC H04L 43/10
USPC 709/224

(57) ABSTRACT

Network management requests may be transmitted in JSON messages over a WebSocket connection to a network device. The network device may process the request and generate a response. The response may be transmitted back over the WebSocket connection in a series of partial response messages. A method of transmitting large data over the WebSocket connection includes transmitting a first message having an identifier value through a WebSocket connection and transmitting a second message having the identifier value through the WebSocket connection, in which the second message comprises an end-of-response indicator.

### FIELD OF THE DISCLOSURE

The instant disclosure relates to computer networks. More specifically, this disclosure relates to storing data in computer networks.

### BACKGROUND

Network administration can often include the generation of various reports, some of which include large amounts of data depending upon the type of report and/or the profile of the computer system. The reports may be requested from client computers and transmitted to a server computer. Although client and server terms are used, they refer to functions rather than hardware capability.

Existing interfaces for generating these network reports include, for example, SNMP and an FTP components. In one example, simple network management protocol (SNMP) requests may be used by a client to initiate report generation, and file transfer protocol (HT) sessions may be used by a client to retrieve the report data. In this example, the dual interface design using both SNMP to make the request and FTP to retrieve the data is used because the SNMP protocol cannot be used to retrieve large amounts of data. However, there are several disadvantages to the use of this dual interface design. Although FTP and SNMP protocols are described in the example provided, reports and other data may be transmitted through other combinations of protocols on a network.

In this dual interface example, a client must configure both SNMP and FTP interfaces for the device being managed and for the client. Second, the use of FTP as the protocol to transfer large amounts of data to the client requires the data to be staged in a file and requires polling by the client to determine when the SNMP interface has completed the report to determine when the report is ready for download through FTP. Further, for long running administrative requests, SNMP is unavailable to provide the client with a progress indication so they can determine how much longer the transfer will take and receive confirmation that progress is still being made. Additionally, the SNMP interface incurs significant overhead in communication. SNMP is a connection-less protocol, due to the use of UDP, and SNMP requires many client requests to obtain data. In addition to the disadvantages described above, networks may not already have SNMP in use on the network. Thus, a client and server would have to configure SNMP solely for network management,

### SUMMARY

A network management agent may provide an interface for requesting and retrieving report data. The data may be transferred through a single protocol. For example, the WebSocket protocol may be used as the underlying protocol with commands, such as the report request and response, being packaged according to the JSON protocol, using the JSON-RPC protocol, on top of the WebSocket connection. The data transmitting through the network management agent may be secured through proper authentication, such as by using a user-id password pair. The agent may employ transport layer security/secure socket layer (TLS/SSL) to encrypt both server authentication and payload data. Although the WebSocket protocol is described above, other protocols may be substituted for the WebSocket protocol.

According to one embodiment, a method may include receiving data for transmission. The method may also include packaging the data as a JavaScript Object Notation (JSON) payload. The method may further include opening a WebSocket connection. The method may also include transmitting the JSON payload over a network through the WebSocket connection.

According to another embodiment, a computer program product may include a non-transitory computer readable medium having code to receive data for transmission. The medium may also include code to package the data as a JavaScript Object Notation (JSON) payload. The medium may further include code to open a WebSocket connection. The medium may also include code to transmit the JSON payload over a network through the WebSocket connection.

According to yet another embodiment, an apparatus may include a memory, a network adapter, and a processor coupled to the memory and coupled to the network adapter. The processor may be configured to receive data for transmission. The processor may also be configured to package the data as a JavaScript Object Notation (JSON) payload. The processor may further be configured to open a WebSocket connection. The processor may also be configured to transmit, through the network adapter, the JSON payload over a network through the WebSocket connection.

According to one embodiment, a method may include transmitting a first message having an identifier value through a WebSocket connection. The method may also include transmitting a second message having the identifier value through the WebSocket connection, in which the second message comprises an end-of-response indicator.

According to another embodiment, a computer program product may include a non-transitory computer readable medium having code to transmit a first message having an identifier value through a WebSocket connection. The medium may also include code to transmit a second message having the identifier value through the WebSocket connection, in which the second message comprises an end-of-response indicator.

According to yet another embodiment, an apparatus may include a memory, a network adapter, and a processor coupled to the memory and coupled to the network adapter. The processor may be configured to transmit, through the network adapter, a first message having an identifier value through a WebSocket connection. The processor may also be configured to transmit, through the network adapter, a second message having the identifier value through the WebSocket connection, in which the second message comprises an end-of-response indicator.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating software for batch execution that processes requests from clients over a network connection according to one embodiment of the disclosure.

FIG. 2 is a flow chart illustrating an exemplary method of transmitting data to a client after batch execution according to one embodiment of the disclosure.

FIG. 3 is a flow chart illustrating an exemplary method of transmitting a data through a partial response to a client according to one embodiment of the disclosure.

FIG. 4 is a call diagram illustrating accessing a hatch execution service with partial response according to one embodiment of the disclosure.

FIG. 5 is a block diagram illustrating a computer network according to one embodiment of the disclosure.

FIG. 6 is a block diagram illustrating a computer system according to one embodiment of the disclosure.

FIG. 7A is a block diagram illustrating a server hosting an emulated software environment for virtualization according to one embodiment of the disclosure.

FIG. 7B is a block diagram illustrating a server hosting an emulated hardware environment according to one embodiment of the disclosure.

### DETAILED DESCRIPTION

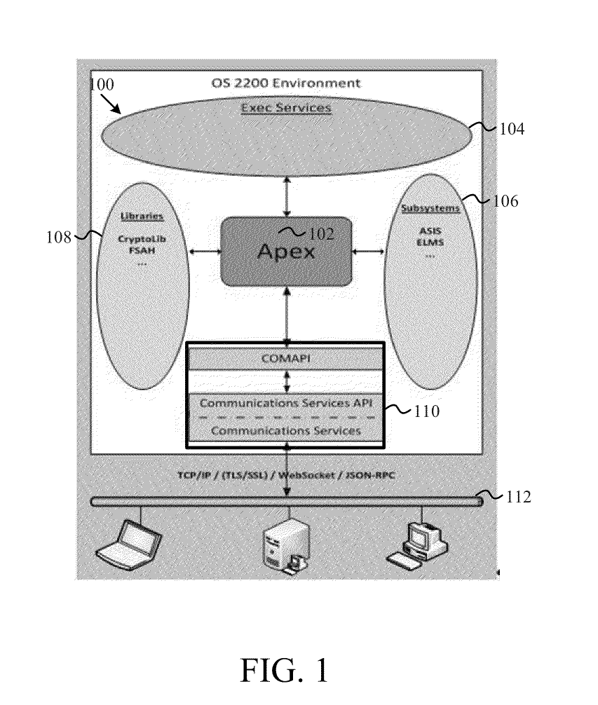

FIG. 1 is a block diagram illustrating software for batch execution that processes requests from clients over a network connection according to one embodiment of the disclosure. A network management service 102 may execute as a service within an operating system 100. The service 102 may communicate with other components of the operating system, such as executive services 104, subsystems 106, and libraries 108. The subsystems 106 may include a semantic interface specification (SIS) and extended language message systems (ELMS). The libraries 108 may include, for example, cryptographic libraries and a free standing audit handler (FSAH). Further, the service 102 may interact with a communications layer 110, including a communications application programming interface (API) and other communications services. The service 102 may communicate with a network 112 through the communications layer 110. For example, communications received and transmitted from the service 102 over the network 112 may be communicated through JSON messages over a WebSocket connection.

Through the service 102, a client may make a remote procedure call (RPC) to the operating system 100 for performing administrative tasks. These administrative tasks may include, for example, generating report data and/or retrieving and updating system configuration values. The service 102 executes as a batch, or background run, that receives input requests from clients on the network 112 over a TCP/IP connection through the communications layer 110. The WebSocket protocol may be used as a transport protocol on top of TCP/IP. Data interchange over the WebSocket protocol may be formatted according to a JSON-RPC protocol, which is a remote procedure call specification that uses JSON for encoding. The RPC requests may be processed by the service 102 and results, if any, may be returned to the client over the same WebSocket connection, also using JSON-RPC encoding. The WebSocket connection may be kept alive to allow clients to make multiple RPC calls over the same connection.

The WebSocket protocol is described in RFC 6455, which is hereby incorporated by reference in its entirety. The WebSocket protocol is used as a communication layer for requests and responses to and/or from clients requesting administration tasks or report generation. The wire format of the data transferred over the socket, both from and to the client, may be framed as defined by the WebSocket protocol.

When a client opens a connection using the WebSocket protocol, the opening handshake received by the server executing the service 102 and the operating system 100 may include a hypertext transfer protocol (HTTP) upgrade request. This initial client to server handshake request may contain a HTTP upgrade header indicating with the value “websocket,” which indicates to the server a request to upgrade to the WebSocket protocol. This HTTP upgrade request may include an HTTP header with a GET request method, which may include “GET /chat,” For the service 102, the GET request uniform resource locator (URL) may be “/apex” or the open request will be rejected by closing the socket.

The remainder of the open handshake response may be validated and, if valid, responded to via a HTTP 101 switching protocol response. If any part of the client handshake sent to the server is incorrect, the socket may be closed. The socket may also be closed if a valid handshake is not received within a predetermined amount of time after the initial socket open is accepted in order to prevent rogue clients or attackers from tying up session slots in the service 102.

Part of the WebSocket handshake protocol may include transmitting a base64-encoded SHA-1 value in the server handshake response header ‘Sec-WebSocket-Accept,’ The value of this header may be created by concatenating the value of the ‘Sec-WebSocket-Key’ header sent in the client handshake with a fixed value, such as the string “258EAFA5-E914-47DA-95CA-05AB0DC85B11,” to generate the SHA-1 hash of the concatenated string and then base64 encoding the result. The SHA-1 hash may be generated using a cryptographic function from the libraries 108.

The service 102 may receive configuration information to be programmed to execute in a particular manner. A configuration file may be written in JSON and include a variety of information. For example, the configuration file may include a destination mode of the API 110, file and characteristics for logging error, warning, and informational events, a key-in-name for receiving console key-ins, a network address endpoint for listening to incoming client requests, a Boolean value indicating secure communications is required, a trace logging level, a filename for trace logging, a filename for cataloging the log file, a file cycle limit, and/or a file cycle interval.

The overall format of the configuration file may conform to the JavaScript Object Notation (JSON) specification. As dictated by JSON, the configuration statement names themselves, such as CallRouterMode. DualModeSockets, etc., may be case-sensitive. Configuration statements defined with the String value type may have their values entered in any case unless the specific configuration statement specifies otherwise. Configuration statements with the Boolean value type may use the JSON values true or false (i.e., lower case and no quotes around the words true and false). Table 1 below shows a sample JSON formatted configuration file.

TABLE 1
A sample JSON formatted configuration file.

{

“Configuration”:
{

“CallRouterMode”: “A”,
“DualModeSockets”: false,
“EventLog”:
{

“CatalogParameters”: “EVENT$LOG.,///5000”,
“CatalogOptions”: “P”,
“FileCycleLimit”: 32,
“FileCycleInterval”: “Daily”

},

“KeyinName”: “APEX”,
“Listen”: “0.0.0.0:443”,
“SecureCommunications”: true,
“TraceLoggingLevel”: “Low”,
“TraceLog”:
{

“CatalogParameters”: “TRACE$LOG.,///5000”,
“CatalogOptions”: “P”,
“FileCycleLimit”: 4,
“FileCycleInterval”: “Daily”

}
}

}

Data interchange between a client device and the service 102 may conform to the JSON-RPC 2.0 specification. The JSON data format is defined in RFC 4627, which is hereby incorporated by reference. Data interchange between the client device and the service 102 may include configuration files, such as that illustrated in Table 1.

After the service 102 receives a request, the service 102 may generate a response and transmit the response to the client. The request may also include commands to generate particular reports. When a report is requested, the service 102 may execute the request and generate the report as a response. The response may be formatted according to the JSON data format as with the request.

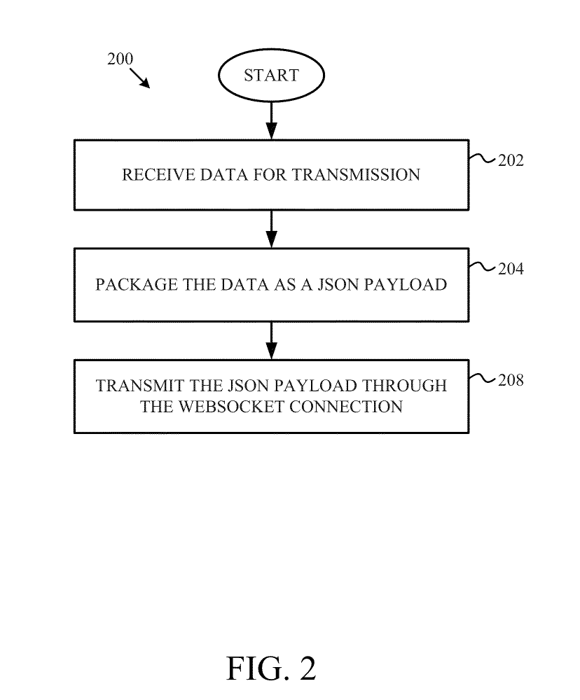

FIG. 2 is a flow chart illustrating an exemplary method of transmitting data to a client after batch execution according to one embodiment of the disclosure. A method 200 begins at block 202 with receiving data for transmission, such as through a WebSocket connection. The data may include, for example, an administrative report. At block 204, the data is packaged as a JSON payload. The service 102 responds through the same WebSocket connection to return the response. At block 208, the JSON payload is transmitted through the WebSocket connection.

The responses generated by the service 102 of FIG. 1 may be large reports. The JSON-RPC specification does not support breaking responses into chunks that can be processed individually by a client. That is because a JSON-RPC response must be complete and a valid JSON-formatted document. Further, the JSON-RPC model is one response for one request, in which the response and request are have the same “id” element. The WebSocket protocol views a message as a single entity that can be sent using multiple frames. The WebSocket protocol expects to receive a complete message and does not have the ability to feed the data to the application a frame at a time.

In one embodiment, progress reports may be sent to the client from the service 102 of FIG. 1 to indicate progress towards completion of a request made in a configuration file transmitted to the service 102. A non-compliant JSON-RPC mechanism may be used to send progress reports to the client. A partial content response may be transmitted to the client, in which each response may be a complete and valid JSON-RPC response sent using a complete WebSocket message. Each response may include the same “id” member value as the request made by the client so that the client may match the response with the original request, in order for the client to detect that the final response has been received for a particular request, the response content may include an indicator that identifies a response as the final output for the original requests.

An example of the partial content response is illustrated in Tables 2-4, which include sample JSON responses. Table 2 is a first partial response indicating 33% progress. Table 3 is a second partial content response indicating 66% progress. Table 4 is a third partial content response indicating 100% progress. Each of the responses in Tables 2-4 may be sent to a client as a complete WebSocket message with a complete and valid JSON-RPC response that the client can parse as it is received. The third message illustrated in Table 4 includes a “true” value for the “FinalChunk” parameter indicating the response is the final response to the request having an “id” value of “1.” The “PercentComplete” parameter includes data to the client to indicate the progress of processing the request. Although “PercentComplete” is shown in the example of Tables 2-4, additional parameters may include other data to assist the client. For example, portions of a large report may be transmitted in a “ReportData” parameter. The client may then assemble all of the “ReportData” values into a large report when the “FinalChunk” parameter indicates the last message was received.

TABLE 2
A first partial content response message of
three partial content response messages.

{

“jsonrpc”:“2.0”,
“id”:“1”,
“result”:{

“FinalChunk”: false,
“PercentComplete”: 33,
“ReportData”:

{

<method defined structure for report output>

}

}

}

TABLE 3
A second partial content response message
of three partial content response messages.

{

“jsonrpc”:“2.0”,
“id”:“1”,
“result”:{

“FinalChunk”: false,
“PercentComplete”: 66,
“ReportData”:

{

<method defined structure for report output>

}

}

}

TABLE 4
A first partial content response message of
three partial content response messages.

{

“jsonrpc”:“2.0”,
“id”:“1”,
“result”:{

“FinalChunk”: true,
“PercentComplete”: 100,
“ReportData”:

{

<method defined structure for report output>

}

}

}

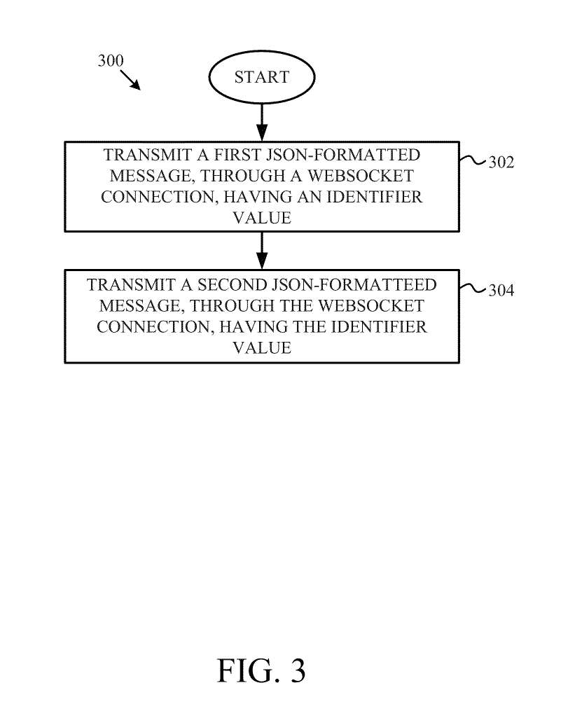

FIG. 3 is a flow chart illustrating an exemplary method of transmitting a data through a partial response to a client according to one embodiment of the disclosure. A method 300 begins at block 302 with the service 102 of FIG. 102 transmitting a first JSON-formatted message, through a WebSocket connection, having an identifier value. At block 304, a second JSON-formatted message is transmitted, through the WebSocket connection, having the identifier value. The second message may include an end-of-response indicator, which indicates to the client the second message is the final message in a series of partial content response messages. Additional messages may be transmitted between the first and second messages.

The client receiving the partial content response messages may be capable of parsing individual chunks of BON and either staging them somewhere (in a collection) or sending the data to the client UI, such as a browser, as the data is received. The client may receive a final message that is empty of any actual data in the event the method processing on the server finishes and all data was already transmitted. In this case, valid JSON-RPC including the “FinalChunk” and “PercentComplete” and other parameters may be sent but the “ReportData” JSON Object would represent no data.

An error response may be sent to the client at any time after a partial content response has been sent. If a client receives an error response at any time, the client may interpret the request as completed in error.

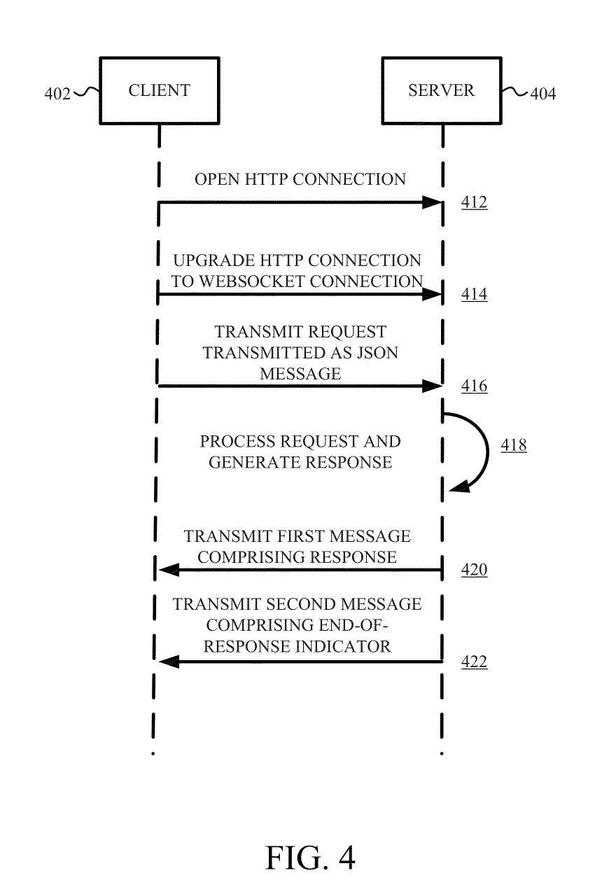

FIG. 4 is a call diagram illustrating accessing a batch execution service with partial response according to one embodiment of the disclosure. At call 412, an HTTP connection is opened by the client 402 to the server 404. At call 414, the client requests an upgrade of the HTTP connection to a WebSocket connection. At call 416, a request is transmitted as a JSON message from the client 402 to the server 404. The request may be, for example, a request to generate an administrative report and/or a request to apply a new configuration to the server 404. When the request is to apply a new configuration, the configuration may be specified in the JSON message carrying the request. At call 418, the server processes the request and generates a response.

At call 420, the server 404 transmits a first message to the client 402 comprising a response to the request of call 416. The first message may be a complete JSON message. At call 422, the server 404 transmits a second message to the client 402 comprising an end-of-response indicator, such as the “FinalChunk” parameter described above. The second message may include the last portion of the response generated at call 418 or the second message may include only the end-of-response indicator. Although not illustrated, other partial response messages may be transmitted from the server 404 to the client 402 before the message of call 422 having the end-of-response indicator.

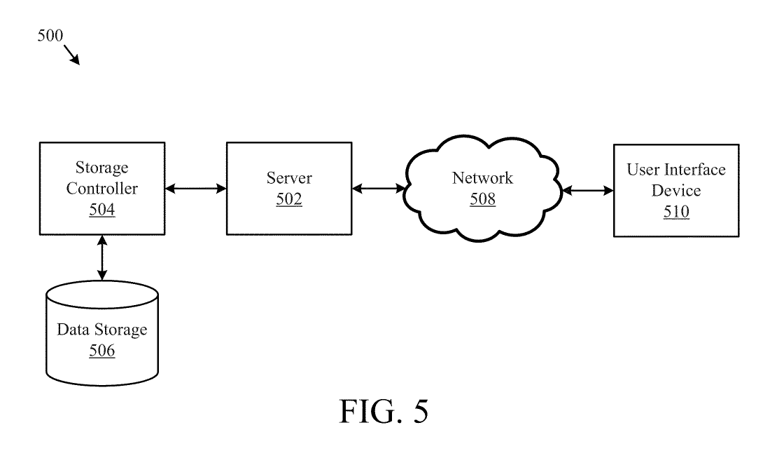

FIG. 5 illustrates one embodiment of a system 500 for an information system, including a system for managing network devices. The system 500 may include a server 502, a data storage device 506, a network 508, and a user interface device 510. The server 502 may also be a hypervisor-based system executing one or more guest partitions hosting operating systems with modules having server configuration information. In a further embodiment, the system 500 may include a storage controller 504, or a storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other mobile communication device having access to the network 508. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area Or local area network to access a web application or web service hosted by the server 502 and may provide a user interface for enabling a user to enter or receive information.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

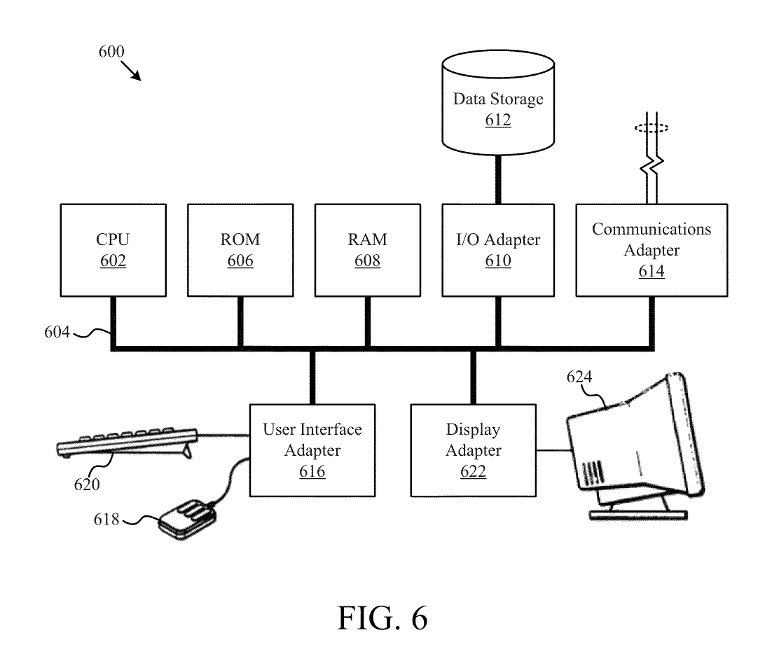

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (RUM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 508, which may be one or more of a. LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical and/or logical.

The applications of the present disclosure are not limited to the architecture of computer system 600. Rather the computer system 600 is provided as an example of one type of computing device that may be adapted to perform the functions of the server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications,

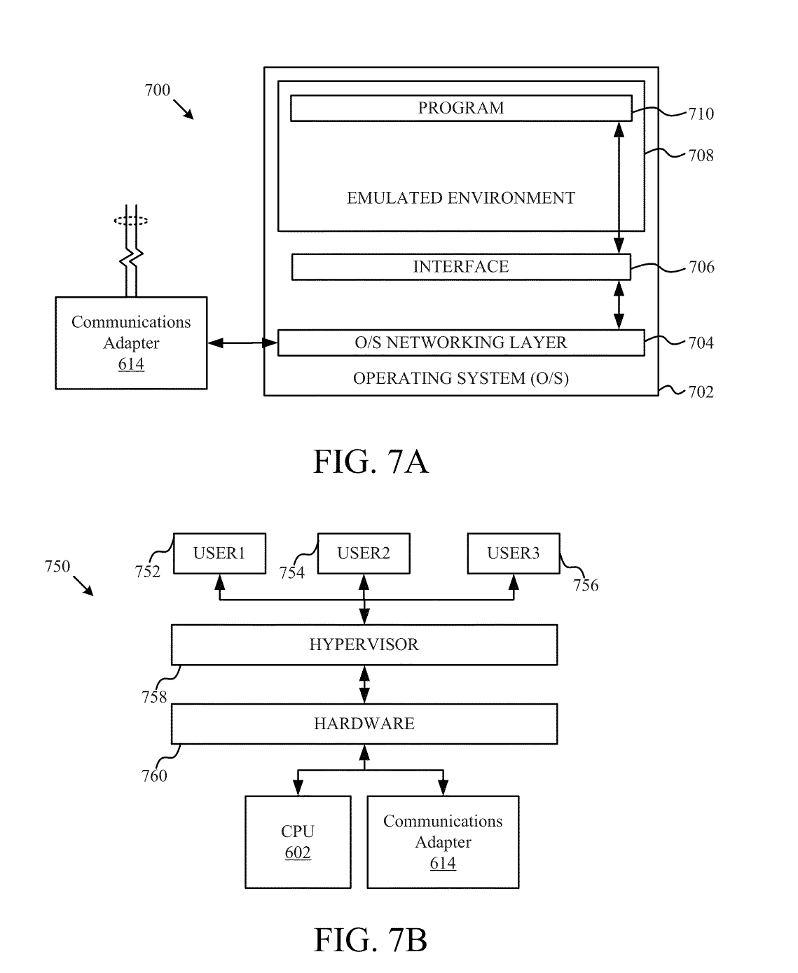

FIG. 7A is a block diagram illustrating a server hosting an emulated software environment for virtualization according to one embodiment of the disclosure. An operating system 702 executing on a server includes drivers for accessing hardware components, such as a networking layer 704 for accessing the communications adapter 714. The operating system 702 may be, for example, Linux. An emulated environment 708 in the operating system 702 executes a program 710, such as CPCommOS. The program 710 accesses the networking layer 704 of the operating system 702 through a non-emulated interface 706, such as XNIOP. The non-emulated interface 706 translates requests from the program 710 executing in the emulated environment 708 for the networking layer 704 of the operating system 702.

In another example, hardware in a computer system may be virtualized through a hypervisor. FIG. 7B is a block diagram illustrating a server hosing an emulated hardware environment according to one embodiment of the disclosure. Users 752, 754, 756 may access the hardware 760 through a hypervisor 758. The hypervisor 758 may be integrated with the hardware 760 to provide virtualization of the hardware 760 without an operating system, such as in the configuration illustrated in FIG. 7A. The hypervisor 758 may provide access to the hardware 760, including the CPU 602 and the communications adaptor 614.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
transmitting a first message having an identifier value through a WebSocket connection; and
transmitting a second message having the identifier value through the WebSocket connection, in which the second message comprises an end-of-response indicator.

2. The method of claim 1, further comprising receiving a request before transmitting the first message and before transmitting the second message, in which the first message is a partial content response to the request and the second message is a partial content response to the request.

3. The method of claim 2, in which the first message is a percentage complete indicator.

4. The method of claim 3, in which the percentage complete indicator comprises an integer.

5. The method of claim 2, further comprising transmitting an error response after the first message, in which the error response indicates the request completed in error.

6. The method of claim 1, in which the first message comprises a complete JSON response and the second message comprises a complete JSON response.

7. The method of claim 1, in which the second message contains no response data.

8. A computer program product, comprising:
a non-transitory computer readable medium comprising:
code to transmit a first message having an identifier value through a WebSocket connection; and
code to transmit a second message having the identifier value through the WebSocket connection, in which the second message comprises an end-of-response indicator.

9. The computer program of claim 8, in which the medium further comprises code to receive a request before transmitting the first message and before transmitting the second message, in which the first message is a partial content response to the request and the second message is a partial content response to the request.

10. The computer program of claim 9, in which the first message is a percentage complete indicator.

11. The computer program of claim 10, in which the percentage complete indicator comprises an integer.

12. The computer program of claim 9, in which the medium further comprises code to transmit an error response after the first message, in which the error response indicates the request completed in error.

13. The computer program of claim 8, in which the first message comprises a complete JSON response and the second message comprises a complete JSON response.

14. The computer program of claim 8, in which the second message contains no response data.

15. An apparatus, comprising:
a memory;
a network adapter; and
a processor coupled to the memory and coupled to the network adapter, in which the processor is configured:
to transmit, through the network adapter, a first message having an identifier value through a WebSocket connection; and
to transmit, through the network adapter, a second message having the identifier value through the WebSocket connection, in which the second message comprises an end-of-response indicator.

16. The apparatus of claim 15, in which the processor is further configured to receive a request before transmitting the first message and before transmitting the second message, in which the first message is a partial content response to the request and the second message is a partial content response to the request.

17. The apparatus of claim 16, in which the first message is a percentage complete indicator.

18. The apparatus of claim 17, in which the percentage complete indicator comprises an integer.

19. The apparatus of claim 15, in which the processor is further configured to transmit an error response after the first message, in which the error response indicates the request completed in error.

20. The apparatus of claim 15, in which the first message comprises a complete JSON response and the second message comprises a complete JSON response.
